(19) United States
(12) Patent Application Publication
(10) Pub. No.: US 2006/0120291 A1
(43) Pub. Date: Jun. 8, 2006

(54) System structure for increasing the performance of data transmission on the internet

(76) Inventor: Chao-Hung Wu, Hsin-Tien City (TW)

Correspondence Address: LEONG C LEI, PMB # 1008, 1867 YGNACIO VALLEY ROAD, WALNUT CREEK, CA, 94598, US

(21) Appl. No.: 11/002,420

(22) Filed: Dec. 3, 2004

(51) Int. Cl. H04L 12/26

(52) U.S. Cl. 370/241

(57) ABSTRACT

A system structure for increasing the performance of data transmission on the Internet is disclosed. By using a routing service system to detect the status (online or not) of each of the workstations and the optimal routing path between the workstations at any time, the routing service system continuously appoint a optimal routing path to the workstations that demand to communicate to each other by using the VoIP or Video conference software. Thus a plurality of workstations can use multimedia software to acquire smooth real time multimedia effect and breakthrough the limitation of applying physical IP network address in traditional video transmission.

### BACKGROUND OF THE INVENTION

(a) Technical Field of the Invention

The present invention generally relates to a system structure for increasing data transmission rate on the Internet, and more particularly to a system structure with a routing server to smoothly communicate between two computers by using multimedia software on the Internet.

(b) Description of the Prior Art

In the VOIP or Video conference, the packets is arbitrarily transmitted to its destination on the Internet according to a setting configured by the ISP when computer A connects to computer B. ISP would not detect the traffic of each channel on the Internet for any packet, and the packet from computer A can arbitrarily arrive computer B via any channel on the Internet. The video or audio in the VOIP or Video conference would suffer the jam of the channel with too many packets, the delay resulted from the far path with too many routing point, or off and on situation caused by the missing part of the packets. The delay, on and off, or unclear situation by using video and audio on the Internet is not yet resolved by any person or any company.

This is because that a huge amount of packets are used during the VOIP or Video conference on the Internet, and it is very difficult to guarantee the packets arrival soon and on time. It is like a high way (Internet) with 8 lanes which can provide 8 cars to run in parallel. It is impossible to provide 12 cars to run in parallel. The 12 cars should run in turn, but then th3 12 cars can not arrive at the same time and the delay, on and off, result occurs. In the prior art, the transmission of the audio and the video on a network with a limited bandwidth depends on the compression technique. Resolving the compression technique, the problem of selecting routing path occurs. There are many path for transmission can be selected and the selection can arbitrary. Each packet is sent to the destination via a most smooth path at the moment to be transmitted. Because the loading of each channel is different at different time, some packets will arrive fast and some packets will arrive late via a busy channel or a channel with many routing point. The effect of the asynchronous transmission decrease the multimedia effect, in particularly the multimedia data is very huge and divided into a huge amount of packets.

However, the problem of multimedia data transmission in market focuses on how to breakthrough the compression technique and the selection of routing path is ignored.

### SUMMARY OF THE INVENTION

The primary purpose of the present invention is to provide a system structure with packets detecting and routing for controlling the routing path in data transmission dynamically.

In view of the prior art, the invention uses a routing service system to dynamically detect and record the status (online or offline) of each workstation on Internet, the shorted and smoothest routing path between the workstations, and the loading of each routing path. When the workstations use the software of VOIP or Video conference to communicate, the routing service system will detect and determine which routing paths between workstations are smoother and shorter. Besides, the routing service system will also detects the loading of the channel to transmit the present data for choosing another optimal routing path to go on transmitting the data to the destination before the highest loading of the present routing path. In the meanwhile, by recording the status of each workstation and recognizing the IP (Internet protocol) type used by each workstation to overcome the limitation of physical network address only in the progress of VOIP or Video conference, wherein the IP type could be a virtual network address or a physical network address.

By using a routing server, data packets can be controlled to arrive to the destination via the most smooth and shortest path. Thus the performance of audio and video between computers in one to one or one to many manners will not be delayed, off and on, and unclear.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

The accompanying drawings incorporated in and forming a part of the specification illustrate several aspects of the present invention, and together with the description serve to explain the principles of the invention. In the drawings:

FIG. 1 shows a diagram illustrating a diagram of the first embodiment of the present invention;

FIG. 2 depicts a diagram illustrating a diagram of the second embodiment of the present invention;

FIG. 3 shows a diagram representing a diagram for control transferring in accordance with an embodiment of the present invention; and

FIG. 4 shows diagram representing another diagram for control transferring in accordance with an embodiment of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

Having summarized various aspects of the present invention, reference will now be made in detail to the description of the invention as illustrated in the drawings. While the invention will be described in connection with these drawings, there is no intent to limit it to the embodiment or embodiments disclosed therein. On the contrary the intent is to cover all alternatives, modifications and equivalents included within the spirit and scope of the invention as defined by the appended claims.

It is noted that the drawings presents herein have been provided to illustrate certain features and aspects of embodiments of the invention. It will be appreciated from the description provided herein that a variety of alternative embodiments and implementations may be realized, consistent with the scope and spirit of the present invention.

It is also noted that the drawings presents herein are not consistent with the same scale. Some scales of some components are not proportional to the scales of other components in order to provide comprehensive descriptions and emphasizes to this present invention.

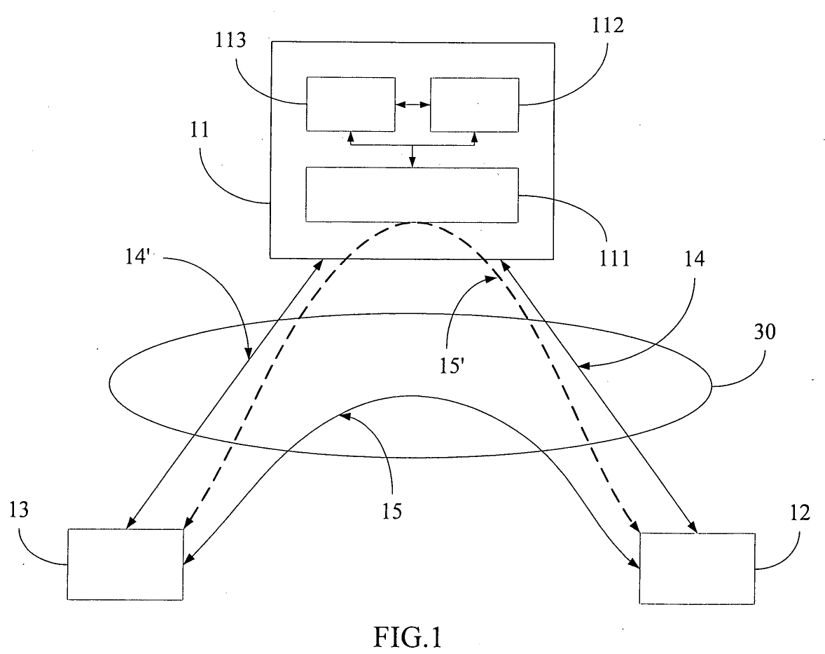

Reference is now made to FIG. 1, which illustrates the structure of the routing service system of the first embodiment of the present invention, including a routing service system 11, Internet network 30, a workstation A 12 (as a data sending end), a workstation B 13 (as a data receiving end). The routing service system 11 includes at least a database 111, a monitor message sending and receiving unit 112, a message handling and determining unit 113. When the present system works, the monitor message sending and receiving unit 112 to use as a heart-beating rule to send detecting signals to each workstation (workstation A 12, workstation B 13) for retrieving the status (online, the usage of virtual network address or the usage of physical network address) of each workstation. The message handling and determining unit 113 determines which routing path between workstation A and workstation B that the workstation A and the workstation B communicate to each other is shortest and smoothest. The routing paths could be path A from workstation A 12 to workstation B 13 or path B from workstation A 12 to workstation B via the routing service system 11. The collected messages are finally restored into the database 111. The heart-beating rule is the manner of sending/receiving messages in an interval or time.

Accordingly, the routing service system 11 will retrieve an optimal routing path 15 (path A is assumed here) from the database 111 and inform workstation A 12 and workstation B 13 the optimal routing path 15. Then workstation A 12 and workstation B 13 transmits packets via the optimal routing path 15. In the meanwhile, the routing service system 11 still sends detecting signals 14 by heart-beating rule to monitor the traffic of the optimal routing path 15 and to collect useful optimal routing path. After monitoring that the loading is raising toward the highest loading of the present optimal routing path 15, the routing service system 13 will appoint a substitute routing path 15′ (path B is assumed here) to workstation A 12 and workstation B 13. Workstation A 12 and Workstation B 13 will use the substitute routing path 15′ in the next cycle to transmit packets after receiving the appointment of new routing path from the routing service system 11. The progress will proceeds until workstation A 12 and workstation B 13 terminate the connection and the routing service system stop the appointment of the routing path between workstation A 12 and workstation B 13. But the status monitoring and recording will not stop.

Because the routing service system 11 collects the statuses of the workstations of the routing service system 11 on the Internet, the IP type of each workstation can be determined. That is, which workstations use the virtual network addresses and which workstations use the physical network addresses can be determined. Moreover, which workstations are behind the fireworks can be also determined, and the limitation of the traditional VOIP or Video conference that only physical address can be used will be breakthrough.

Accordingly, each packets of computers after booting are controlled by the routing service system 11, thus the packets can pass through the firewall. No matter the virtual network address or the physical network address is used, the audio and video data can be real time transmitted. In the meantime, the routing service system 11 can confirm and get over the IP type of the two parties or the multi-parties, the transmission can be either between two workstations or between several workstations. Moreover, the arrival of packets can be guaranteed and not delayed.

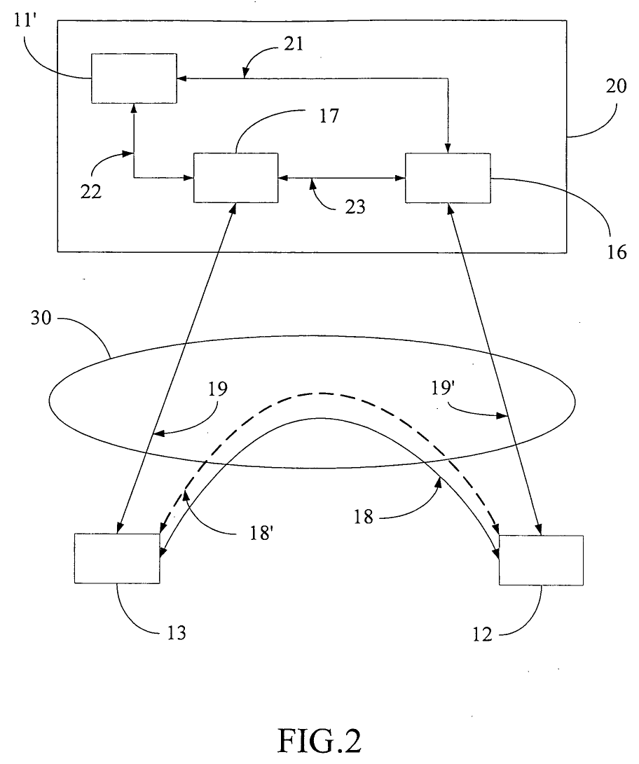

Reference is now made to FIG. 2, which illustrates the structure of the routing service system of the second embodiment of the present invention. The difference between FIG. 1 and FIG. 2 is that the routing service system includes at least a routing server A 11′, a routing server B 16, and a routing server C 17, wherein each routing server is equal to the above mentioned routing service system 11, including at least a database 111, a monitor message sending and receiving unit 112, a message handling and determining unit 113. The routing server A 11′ is on the top of the tree structure, so the routing server A 11′ sends detecting signals 21, 22 to the routing server B 16 and the routing server C 17 separately. Thus the routing server A 11′ can also be called routing server center, and it controls and commands the other routing servers 16, 17 on the layer below it to transmit packets to each other. Assume that routing server B 16 can only control workstation A 12 and the routing server C 17 can only control workstation B 13. The routing server B 16 sends detecting signal 19′ to the workstation A and the routing server C 17 sends detecting signal 19 to the workstation B. Besides, the routing server B 16 and the routing server C 17 are in different LANs (local area network). When workstation A 12 demands to connect to workstation B 13 and the database 161 of the routing server B 16 lacks the corresponding status information of workstation B 13, the routing server B 16 can acquire the status information of workstation B 13 from the routing server C 17 via the routing server on the above layer (routing server A 11′). With the control by the routing server center (the manner of controlling equals to the first embodiment), routing server B 16 and routing server C 17 are control to acquire the status information of workstation A 12 and workstation B 13 on the Internet in a short time. Besides, the routing server center will find a optimal routing path 18 between workstation A 12 and workstation B 13. Then workstation A 12 and workstation B 13 can transmit packets via the optimal routing path 18 after receiving the appointment. Similarly, a substitute optimal routing path 18′ will be appointed to workstation A 12 and workstation B 13 when routing server B 16 or routing server C 17 find that the loading of the optimal routing server approaches the limitation.

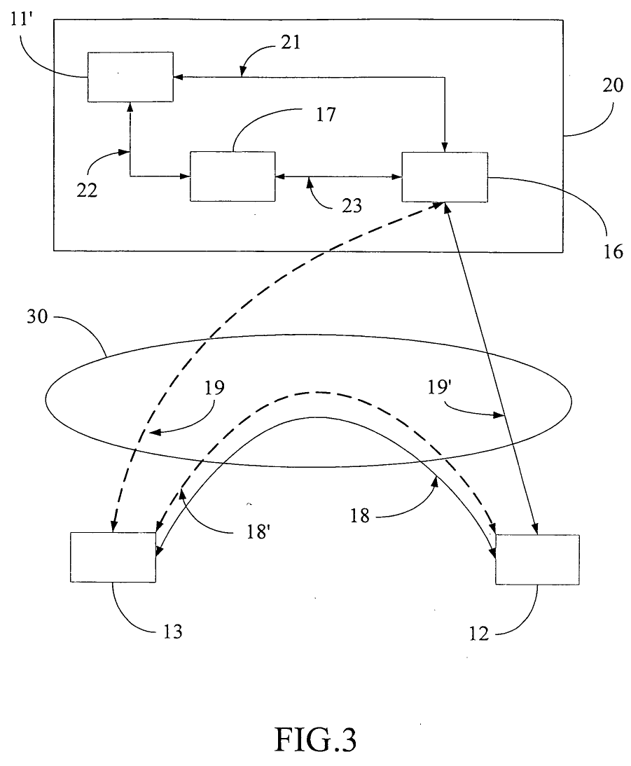

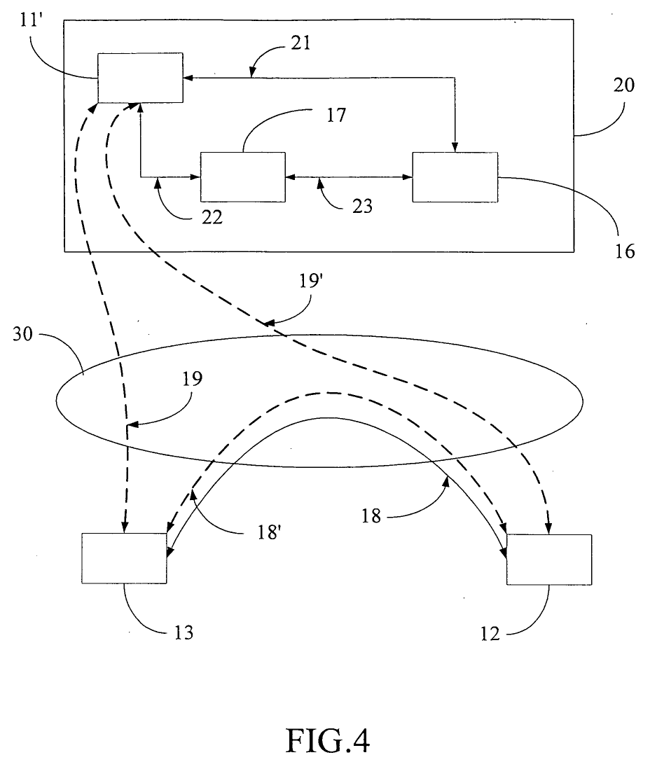

In the above discussion, the controlling for workstation A 12 and workstation B 13 can be transferred to routing server B 16 or routing server C 17 after workstation B 16 and workstation C 17 acquiring the status information of workstation A 12 and workstation B 13 separately or in the progress of data transmission between workstation A 12 and workstation B 13. That is, the routing server with best performance takes the control of the routing path for data transmission, monitors and records the status. Referring to FIG. 3, comparing to FIG. 2, the control of routing server C 17 over workstation B 13 is transferred to routing server B 16. Next, referring to FIG. 4, the statuses and the controls of workstation A 12 and workstation B 13 can be taken by the routing server center, whereby the routing server center controls the optimal routing path, monitors and records status messages with fill powers.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A system structure for increasing the performance of data transmission on the Internet, constructed by a routing service system, a Internet, and a plurality of workstations, wherein said routing service system includes at least a database, a monitor message sending and receiving unit and a message handling and determining unit, said system structure for increasing the performance of data transmission on the Internet is characterized in that:
said monitor message sending and receiving unit continuously sends detecting a signal to each of said workstations according to a heart-beating rule for acquiring and storing the control of data transmission, the status, and all possible routing paths of each of said workstation into said database, wherein said workstations transmit data packets on the Internet according to a optimal routing path appointed from the routing service system.

2. The system structure for increasing the performance of data transmission on the Internet of claim 1, wherein said status includes:
whether said workstation is online or not, the type of Internet Protocol (IP) address of said workstation.

3. The system structure for increasing the performance of data transmission on the Internet of claim 1, wherein said heart-beating rule is a manner to sending/receiving messages in a fixed interval.

4. The system structure for increasing the performance of data transmission on the Internet of claim 1, wherein said wherein said heart-beating rule is a manner to sending/receiving messages in a fixed times.

5. The system structure for increasing the performance of data transmission on the Internet of claim 1, wherein said routing service system is a routing server.

6. The system structure for increasing the performance of data transmission on the Internet of claim 1, wherein said routing service system is constructed as a tree structure by a plurality of routing servers, wherein said plurality of routing servers include a routing server center.
